(19) United States
(12) Patent Application Publication
(10) Pub. No.: US 2007/0019679 A1
(43) Pub. Date: Jan. 25, 2007

(54) Mobile communications network with multiple radio units

(75) Inventors: Hans-Otto Scheck, Espoo (FI); Timo Viero, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/477,773

(22) Filed: Jun. 30, 2006

(30) Foreign Application Priority Data
Jul. 1, 2005 (GB) 0513583.5

(51) Int. Cl. H04J 1/00

(52) U.S. Cl. 370/480

(57) ABSTRACT

A wireless communications system comprising: a plurality of radio units each comprising at least one antenna for receiving a radio frequency signal over a wireless interface, a converter for converting the radio frequency signal to a digital signal and a digital link for conveying the digital signal; a digital combiner for receiving the digital signals from the plurality of radio units and combining the digital signals in the digital domain to generate a resultant digital signal and having a digital link for conveying the resultant digital signal; and a processing unit arranged to receive and process the resultant digital signal.

The present invention relates to a mobile communications network with multiple radio units, particularly but not exclusively with antenna elements arranged for improved coverage.

It is well known that the location of antenna elements of a base transceiver station plays a crucial role in the quality of transmitted and received radio signals, and therefore has a strong impact on the capacity of the base transceiver station and the entire cellular telecommunication system.

It is customary to locate the antenna elements such that the coverage of the cell of the base transceiver station is as good as possible in the cell area. A good coverage may be obtained, for example, by locating the antenna elements in elevated sites by using masts dedicated for wireless communication or other high constructions, such as buildings, while other parts, such as radio frequency parts and base band parts, of the base transceiver station are located on the ground far from the antenna elements.

A physical distance between the antenna elements and the other parts of the base transceiver station involves a power distribution system for relaying electric signals between the antenna elements and the other parts of the base station. The power distribution system may comprise branches to a plurality of antenna elements if antenna groups are utilised. The power distribution system may comprise cables, such as co-axial cables, between the transceiver of the base station and the antenna elements and possibly mast amplifiers used as pre-amplifiers.

The electric characteristics of the power distribution system give rise to electric disturbance, such as loss and retardation, in the signals transmitted between the antenna elements and other parts of the base transceiver station. Especially, if multi-antenna techniques are utilised, the power distribution system may comprise branches with different electric characteristics, thus distorting the relative signal characteristics of the antenna signals, and reducing the quality of transmission and reception of the base transceiver station. The reduction in the quality of the transmission and reception further leads to lowering capacity of the base transceiver station and the entire cellular telecommunication system.

Our earlier U.S. patent application Ser. No. 10/446,144/Docket No. 60091.00201 (Nokia Ref. NC 39903) describes an improved antenna arrangement and a base transceiver station for reducing problems associated with the RF power distribution between a base station and antenna elements of the base transceiver station. In that arrangement, an active antenna converts between a digital signal and a radio frequency electromagnetic field.

The digital signal transmitted between the remote radio units and the base band parts of the base station together with the integrated structure of the transceiver and the antenna element enable a distributed base station BTS where the active antennas are located relatively far from the base band parts of the base transceiver station.

A digital link provides several advantages over analogue links. The bit form of the information enabled by the digital link, for example, enables reliable and flexible information transfer, since losses in the digital link have a small effect on the information content transferred by the digital link.

The digital signal can be implemented by using optical radiation such that the information carried by the digital signal is coded digitally as intensity variation of the optical radiation.

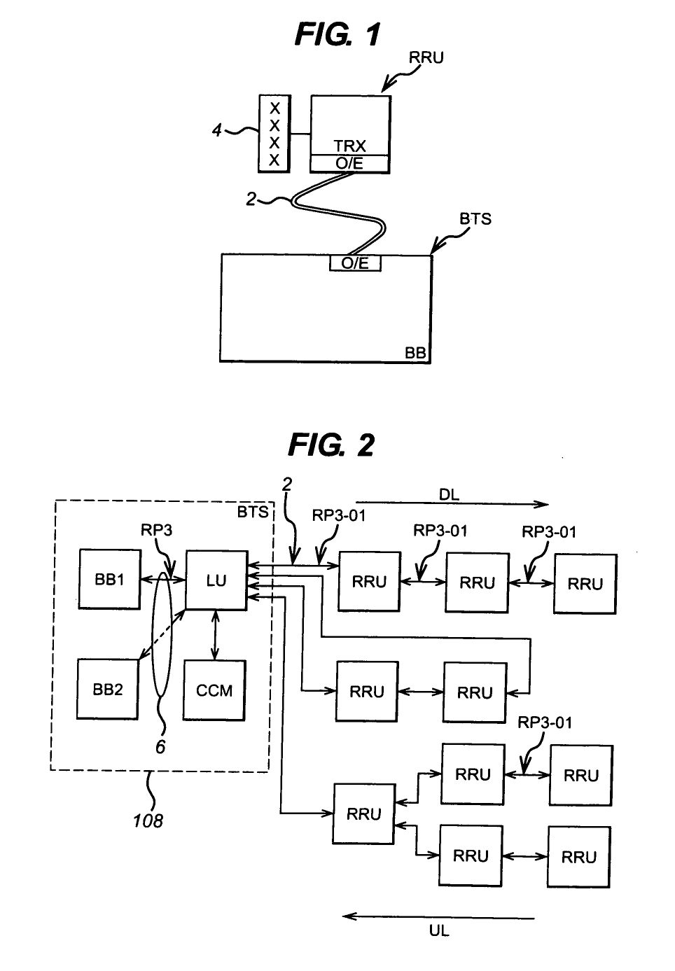

FIG. 1 is a schematic diagram illustrating the principles of one existing scheme for implementing a base station BTS in a mobile communications network. The base station is implemented as a distributed set of base band processing units BB, one of which is shown in FIG. 1. Each base band processing unit BB has an optical digital interface O/E which communicates with a transceiver TRX over an optical fibre link 2. Alternatively a common system box in a BTS has the O/Es. The transceiver is connected to multiple antennas 4. Thus, each radio unit RRU is connected to transmit the antenna signal digitally via an optical link 2 to a dedicated base band processing unit BB in the base station BTS.

FIG. 2 illustrates in more detail a distributed base station architecture. The base station comprises a plurality of base band modules BB1, BB2, two of which are shown in FIG. 2. A local unit LU is connected to receive incoming signals from a plurality of RF units RRU and perform a protocol transformation between the signals between the RRUs and the local unit LU and the protocol used between the local unit LU and the internal base band modules BB1, BB2, etc. In OBSAI (Open Base Station Architecture Initiative, see http://www.obsai.org) the RP3-01 protocol is used between the base station and the RF units RRU, while CPRI (Common Public Radio Interface, see http://www.cpri.info) has another protocol defined for the same use.

A Control and Clock Module (CCM) provides a BTS reference clock as well as main control of the BTS.

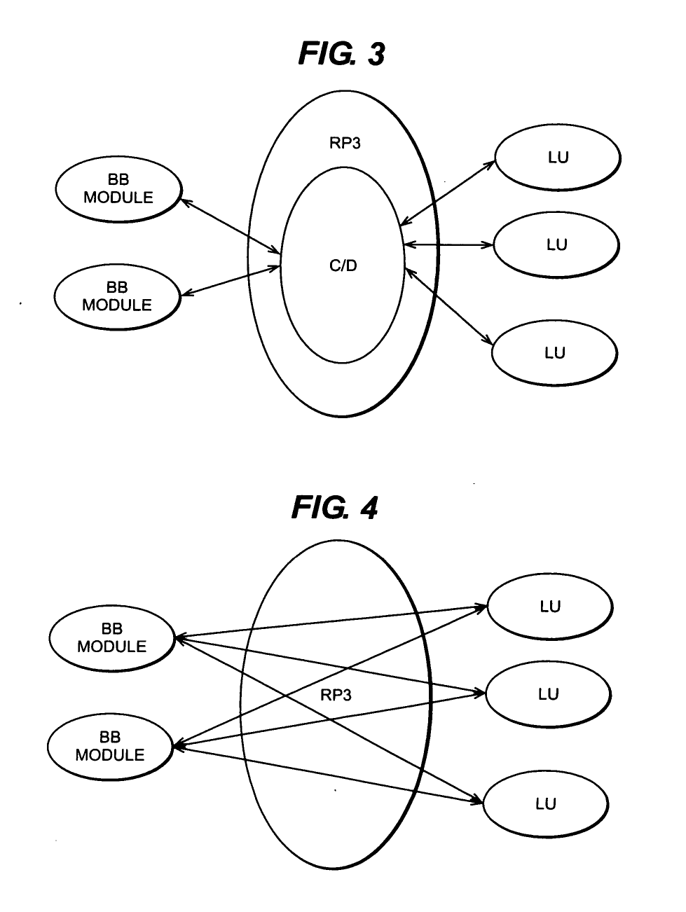

The base station includes a switch 6 for connecting the local unit LU to any particular base band module BB. The switch 6 can take the form of a centralised architecture connection (FIG. 3) which interconnects a plurality of local units with individual base band modules using the RP3 protocol. Alternatively, the switch 6 can take the form of a mesh architecture connection (FIG. 4) between each of a plurality of local units LU and individual base band modules BB, once again using the RP3 protocol. The details of the switch are not important, but it will be appreciated that any appropriate routing architecture can be utilised. What is important however is the capacity of each RP3-01 link (between the RF units RRU in FIG. 2) and the RP3 links between the local units LU and the base band modules BB. This is particularly the case in a widely distributed BTS configuration where several RF units are utilised. In-building coverage and wide area solutions with remotely located RF units (with kilometres of cell radius) are examples of distributed BTS solutions where LU-BB capacity may become an issue.

In the light of FIGS. 1 and 2 it will be appreciated that the switch 6 illustrated in FIG. 2 performs the function of directly connecting any particular RF unit RRU to a selected base band module BB. That is, the switch 6 must provide for all possible paths coming into the local unit LU to be interconnected to a base band module BB. It will be appreciated in view of FIGS. 1 and 2 that the links between the RF units RRU and the local units LU are by way of optical fibre links 2 with the RP3-01 protocol.

Each BB module can process a set of RF signals or antenna-carrier signals. The switch will be programmed by CCM to “select” the antenna-carrier signals for each BB module. The BB modules can process the same RF signals (small BTS) or there can exist several groups of BB modules each group of BB modules processing different signals (but the same ones within a group). Where multiple RF units are required to achieve sufficient radio coverage for an area with low traffic, precious base band processing capacity has to be deployed without sufficient return on investment.

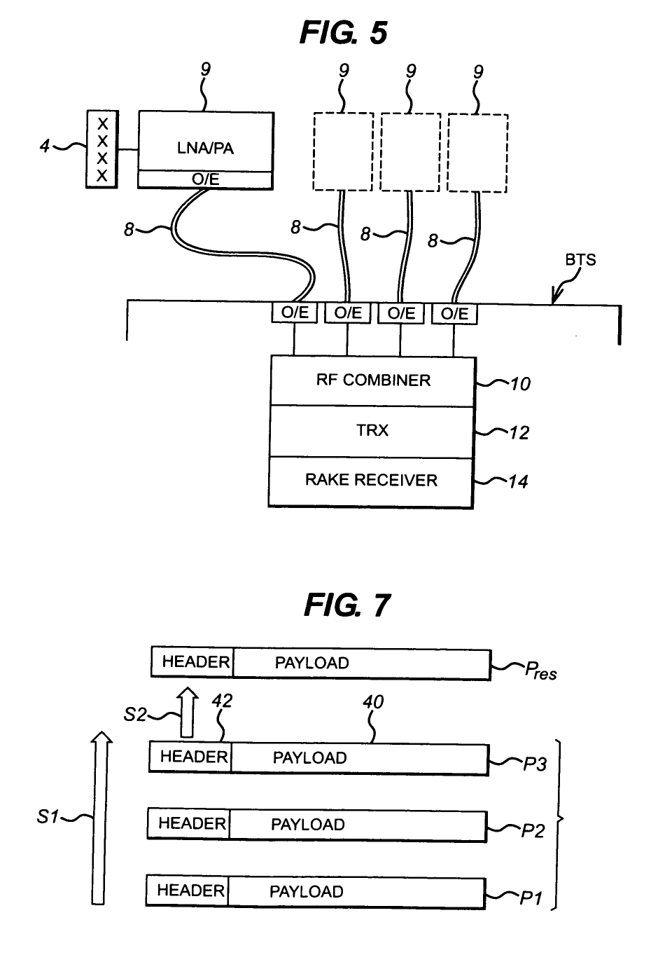

FIG. 5 illustrates an existing advanced in-door radio (AIR) system. In this case, individual antenna units LNA/PA (Low Noise Amplifier/Power Amplifier), each associated with a set of antennas 4, provide analogue RF signals over optical fibre connections 8 to the base station BTS. On the uplink side the analogue RF signals are combined in an RF combiner 10 which acts as a simple analogue power combiner. In this way, the signals from up to twelve antenna units can be combined into a single transceiver signal at a transceiver TRX 12. It will be appreciated that twelve is just an example from AIR, and any number could be utilised. A RAKE receiver 14 then processes the transceiver signal in the normal way. On the downlink side, the RF combiner 10 distributes analogue signals to different optical fibre connections depending on the intended antenna for the signal, the same signal to all optical links.

In the scenario of FIG. 5, transmission and combining of the RF signals is performed in the analogue domain, which limits the maximum range and performance of such a solution due to the requirement to use non-ideal analogue components.

It is an aim of the present invention to minimise installed base station processing capacity where possible, without affecting coverage or performance.

According to one aspect of the present invention there is provided a wireless communications system comprising: a plurality of radio units each comprising at least one antenna for receiving a radio frequency signal over a wireless interface, a converter for converting the radio frequency signal to a digital signal and a digital link for conveying the digital signal; a digital combiner for receiving the digital signals from the plurality of radio units and combining the digital signals in the digital domain to generate a resultant digital signal and having a digital link for conveying the resultant digital signal; and a processing unit arranged to receive and process the resultant digital signal.

Another aspect of the invention provides a digital combiner for use in a wireless communications system having a plurality of radio units each capable of generating a digital signal representative of a radio frequency signal received over a wireless interface, the digital combiner being operable to receive digital signals from the plurality of radio units and to combine the digital signals in the digital domain to generate a resultant digital signal, wherein the digital combiner further comprises a digital link for conveying the resultant digital signal.

The digital link of each radio unit and/or of the digital combiner can be an optical fibre link.

Each digital signal can take the form of a sequence of packets, each packet comprising a header and a payload, the payload including digital samples representing the radio frequency signal. In that case, the digital combiner is operable to sum the digital samples of the payloads of the packets of respective digital signals to generate the resultant digital signal, preferably in the form of a sequence of packets whose payload portion is generated by the summed samples of the payload portions of the packets of the digital signals, and a header portion generated from the headers of packets of the digital signals.

The processing unit preferably includes a RAKE receiver which is operable to process the resultant digital signal in a number of different situations. Where said plurality of radio units are located in a common location for receiving a single radio frequency signal over a plurality of differing paths, the RAKE receiver is operable to process the resultant digital signal in that environment, wherein the radio frequency signal is encoded using a spreading code.

Where the plurality of radio units are located to receive separate radio frequency signals encoded with differing spreading codes, and possibly received via differing paths, the RAKE receiver is operable to process the resultant digital signal in that environment.

It will be appreciated that differing paths can give rise to differing path delays and attenuations.

The digital signal from each radio unit can be conveyed with a predetermined data rate. The digital combiner can be operable to decimate the date rate of each of the received digital signals so that the resultant digital signal has a data rate corresponding to one of said digital signals or a one bit overhead per connected radio unit.

The mobile communications system can comprise a transmitter arranged to receive a combined digital signal and to generate therefrom a plurality of individual digital signals and to convey said digital signals over respective digital links associated with each of the plurality of radio units. The transmitter can encode each of the digital signals with the same spreading code or with different spreading codes.

The following described embodiment of the present invention allows installed base station capacity to be minimised in a simple and cost efficient way, while still providing sufficient antenna coverage. Embodiments of the invention can be used to combine multiple wide area sectors in a high power base station at roll-out when only a fraction of the expected capacity is required, or to combine multiple local area units for in-building coverage.

The invention is particularly useful in an application where the amount of RF units is high compared to the base band capacity needed to process the signals from those units. In this situation there is the benefit in savings of base band capacity. One such situation is indoor coverage where only a small capacity is needed, and another such situation is outdoor coverage for a very large area with low traffic.

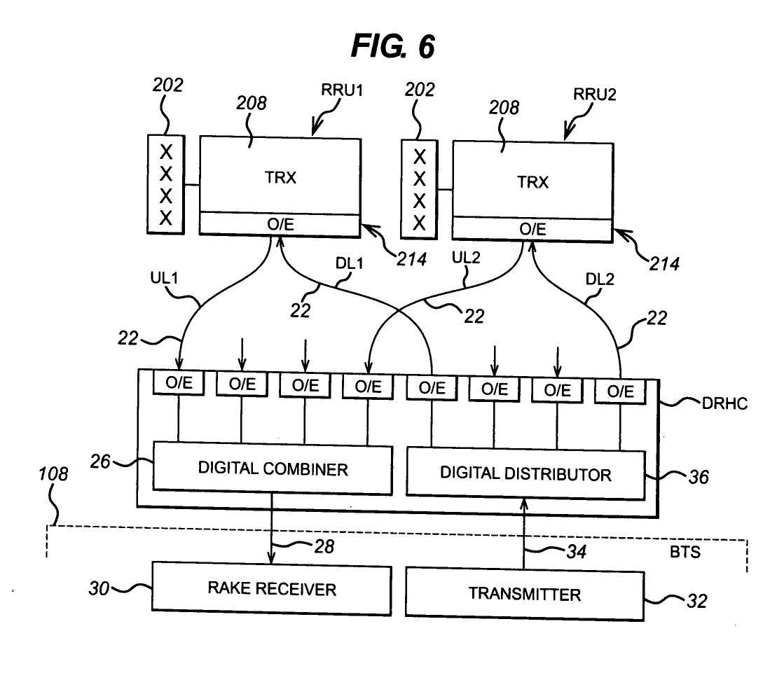

For a better understanding of the present invention and to show how the same may be carried into effect, reference will now be made by way of example to FIGS. 6 to 10 of the accompanying drawings in which:

FIG. 1 is a schematic diagram of an existing scheme for implementing a base station with a remote radio unit.

FIG. 2 is a schematic diagram of a distributed base station architecture with digital interface;

FIG. 3 is a schematic diagram of one form of a configuration switch;

FIG. 4 is a schematic diagram of an alternative form of a configuration switch;

FIG. 5 is a schematic block diagram of a base station utilizing radio over fibre, implemented with analogue combining;

FIG. 6 is a schematic block diagram illustrating the principles of one embodiment of the invention;

FIG. 7 is a diagram illustrating the combining packets;

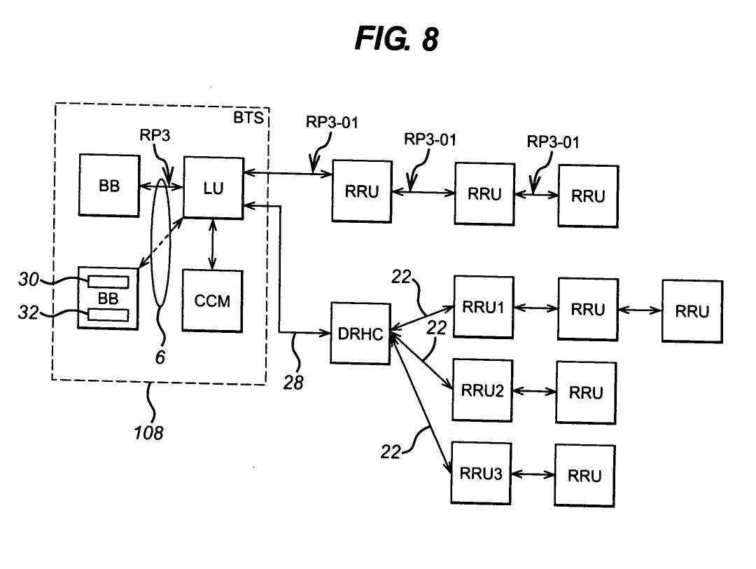

FIG. 8 is a schematic block diagram of a distributed base station architecture implementing one embodiment of the invention;

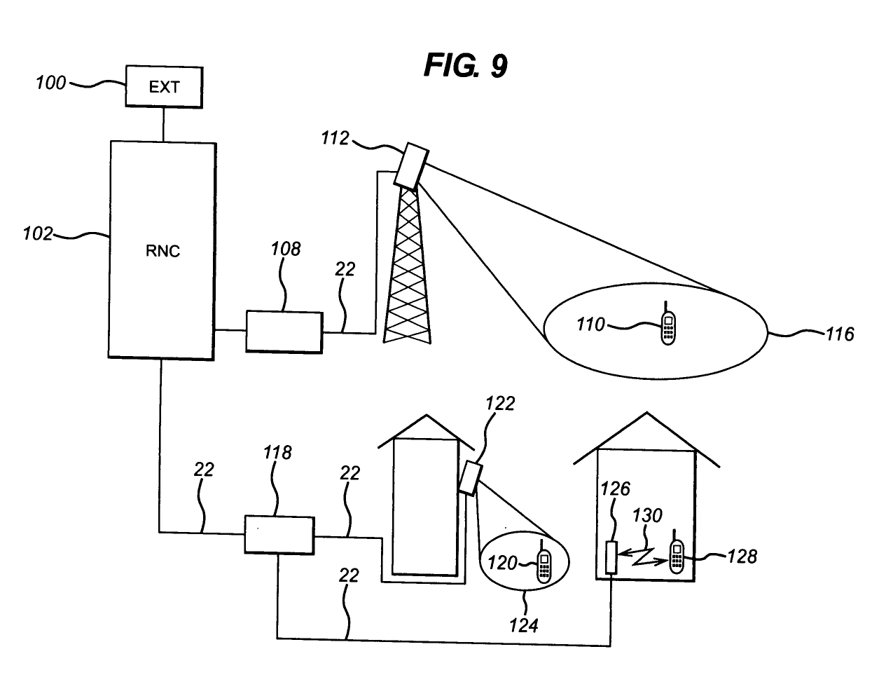

FIG. 9 is a schematic diagram of an environment in which the invention can be utilised; and

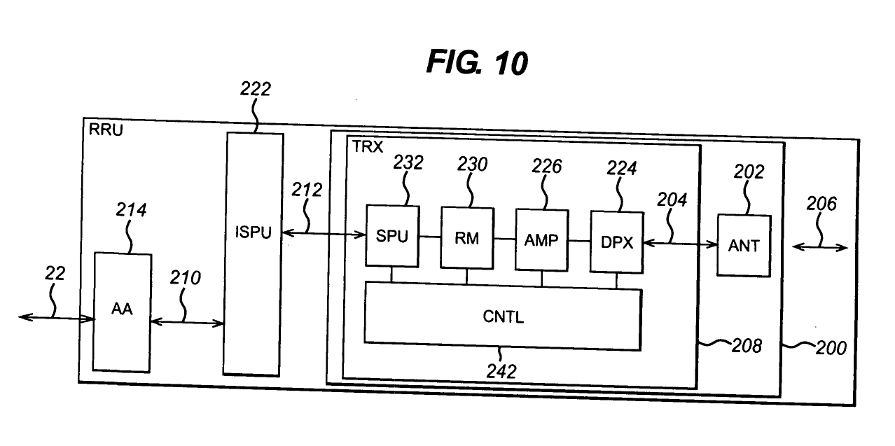

FIG. 10 is a block diagram of one implementation of an RF unit.

An embodiment of the invention will now be described herein with reference to FIG. 6 which illustrates the principles of the scheme.

FIG. 6 illustrates a mobile communications network having a plurality of RF units, two of which are shown RRU1, RRU2. Each RF unit is associated with an antenna set 202 and comprises a transceiver TRX 208 and an adaptor 214 providing an optical digital interface O/E in a manner similar to that described in relation to FIG. 1. In particular, each RF unit RRU contains the ability to convert an RF signal into a digital signal which can be conveyed via an optical fibre link 22. In contrast to FIG. 1 however in the architecture of FIG. 6, the uplink signals from the RF units RRU1, RRU2, labelled UL1, UL2 are transmitted from the digital optical interface O/E of the RF unit to a respective digital optical interface O/E of a digital radio head combiner DRHC. In FIG. 6, DRHC is shown as having four digital optical interfaces, the first and the last receiving the uplink signals from the illustrated RF units RRU1, RRU2 respectively while the middle two receive similar digital signals from other RF units which are not shown in FIG. 6. The uplink signals UL1, UL2 are transmitted over optical fibre links 22. The DRHC is also illustrated as having transmit digital optical interfaces which respectively transmit downlink signals in a digital format, DL1, DL2 being illustrated, to the RF units RRU1, RRU2. This transmission is also over optical fibre links 22. The DRHC performs two functions. On the uplink side, the DRHC implements a digital combiner 26 which receives the digital signals from each of the optical interfaces and combines them to provide a single resultant digital signal 28 to a RAKE receiver 30 at a base station BTS 108.

No specific description of the RAKE receiver is given here because they are known to a person skilled in the art. For example a standard RAKE receiver can be applied (see e.g. J. G. Proakis, Digital Communications, McGraw-Hill, New York, 1995).

On the downlink side, a transmitter 32 at the base station provides a single combined signal 34 to the DRHC which implements a digital distributor 36. The digital distributor separates the combined signal 34 to distribute it across the multiple optical interfaces O/E and thereby to individual ones of the RF units RRU connected to the DRHC. Referring to FIG. 6, there exist four links from the RRUs to the digital combiner 26 and only a single link from the digital combiner 26 to the BB/RAKE receiver 30. Data rate in all of the links can be the same. Thus, the digital combiner performs decimation (i.e. data rate reduction) when summing the four input signals together. Alternatively, data rate at the output link may be little bit higher if applying more bits per sample due to summing than in the input links. For example, if all of the N input links have 8+8 bits (8 for I and 8 for Q samples) then at the output we can at maximum have (8+N)+(8+N) bits for I and Q. On the downlink a dedicated signal can be created for each RF unit or the same signal is copied to several RF units.

A key advantage of this arrangement is that the Lu interface (28, 34) see the DRHC as one single RRU—it does not distinguish between the RRUs behind the DRHC.

FIG. 7 illustrates the operation of the digital combiner 26 of a DRHC, which is operative in the uplink direction.

FIG. 7 illustrates three packets P1, P2 and P3 which are assumed to have come in as digital signals on respective uplink paths to the digital optical interfaces of the DRHC. The digital signal has a predetermined frame structure, wherein each frame and/or portion of a frame has frame-specific information such as payload data and control information. These packets include antenna carrier (RF) signal samples embedded in a payload part 40 of the packet according to the specific frame structure in line with a particular protocol. Each packet also includes a header 42 which identifies, amongst other things, the source of the packet in terms of its dispatching RF unit. The digital combiner 26 examines the headers 42 of the incoming packets P1, P2 and P3 and determines on the basis of the information in the headers which packets can be combined. Packets are combined by simple addition of the RF samples contained in the payload portions. This is illustrated by the arrow Step S1 where it is assumed that all of the packets P1, P2 and P3 are to be combined in this way.

This results in a payload of a resulting packet P_{RES}. The header of the resultant packet is generated from the headers of the incoming packets based on base station O&M (operation and maintenance) instructions. The combined packet P_{RES} is supplied as the resultant signal 28 to the RAKE receiver 30 for processing.

The described embodiment of the present invention is implemented in a code division multiplex access (CDMA) environment, where a spreading code is used to uniquely identify an RF signal. Where multiple RF units are used to provide a single signal, this means that multiple RF units may be using the same spreading code to supply their signal to the DRHC. The RAKE receiver is operable to process the resulting packet P_{RES} in such a situation, that is multiple radio signals with the same spreading code but possibly with different path delays and attenuations.

A determination may also be made to combine uplink signals from RF units with different origins and different spreading codes. In this case, the RAKE receiver is operable to process a resulting packet P_{RES} which contains combined information from all of these signals.

FIG. 8 is a schematic block diagram of one embodiment of the invention with an antenna architecture similar to that of the earlier described FIG. 2. That is, a plurality of RF units RRUs are distributed throughout an area, with three of the RF units RRU1, RRU2 and RRU3 being shown connected to the digital RF head combiner by way of optical links 22. The digital radio head combiner is connected to the base band processor via a digital link, or another link e.g. optical fibre link or radio link, which carries the resultant signal 28. The local unit LU receives the resultant signal and is capable of switching it via the switch 6 to one of the base band modules BB for processing. The base band module to which it is switched includes a RAKE receiver 30 for the preferred application in WCDMA systems capable of implementing the processing described above. The RAKE receiver could be replaced with a TDD, OFDMA or other baseband processor according to the targeted communication system. The base band module also includes the transmitter 32.

The cellular telecommunications system is based on, for example, but not limited to r WCDMA (Wideband Code Division Multiple Access) technology. The structure and function of cellular telecommunications systems are known to a person skilled in the art, and only network elements relevant to the invention will be described.

FIG. 9 is a schematic diagram of an architecture in which the above embodiment of the invention can be utilised.

A radio network controller (RNC) 102 acts as an interface between the core network and the radio access network. References 108, 118 represent network elements, such as node Bs, which implement the radio interface in the cellular telecommunication system. The invention is not, however, restricted in the presented structure of the cellular telecommunication system, but can be applied to any mobile telecommunication system, including packet switched networks.

The telecommunication system further comprises user equipment 110, 120, 128 for providing a user with access to the cellular telecommunication system. The user equipment 110, 120, 128 may comprise conventional components, including wireless modems, processors with software, memory, a user interface, and a display. The structure and functions of the user equipment 110, 120, 128 are known to a person skilled in the art.

FIG. 9 shows the structure of the coverage area of the exemplified cellular telecommunication system and implementation thereof. The node B 108 provides the user equipment 110 with a macro-cell 116, whose coverage area may range from hundreds of metres to several kilometres. In order to obtain such a large coverage area, the antenna element 112 may be located in an elevated location, such as the top of a mast. The macro-cell 116 may also represent an adaptive cell, which can dynamically be directed at the user equipment 110 according to the prevailing location and capacity requirement of the user equipment 110.

A smaller cell size may be employed in order to improve the coverage area provided by the macro-cell 116 or to form high capacity sites. Examples of such smaller cells include e.g. a micro-cell 124 and a pico-cell 130 are shown. A base transceiver station 118 may provide several micro- and/or pico-cells. The size of a micro-cell 124 may range from hundreds of metres to dozens of metres while the size of a pico-cell 130 may range from metres to centimetres.

The antenna element placement in the micro- and pico-cell implementations may vary. Micro-cell antenna elements 122 may be located in buildings or at a wall of a building while pico-cell antenna elements 126 are usually located in the proximity of the users in order to obtain direct visibility.

The cell implementations utilise a base transceiver station structure wherein the antenna element 112, 122, 126 is located far from the other parts of the base station 108, 118. In the above embodiment, optical fibre links 22 are used to connect the antenna element 112 and the other parts of the base transceiver station 108, 118.

While cellular systems are exemplified herein, it will be appreciated that mobile networks which do not use a cellular structure are also envisaged.

For the sake of completeness, FIG. 10 shows in more detail one embodiment of an RF unit RRU.

The RF unit RRU comprises at least one active antenna 200. Each active antenna 200 comprises an antenna element 202, and a transceiver 208 coupled and integrated at least partially with the antenna element 202.

In transmission, each antenna element 202 receives a radio frequency transmit signal 204 from the transceiver 208 and converts the radio frequency transmit signal 204 into a radio frequency electromagnetic field 206 which may as such compose a radiation pattern or produce elementary components in an overall electromagnetic field produced in superposition with other antenna elements. The electromagnetic field 206 enables a downlink connection between the base transceiver station 108, 118 and user equipment 110, 120, 130.

In reception, the antenna element 202 converts a portion of the radio frequency electromagnetic field 206, produced by a radio signal source, such as user equipment 110, 120, 130, into a radio frequency receive signal 204 to be fed into the transceiver 208. In reception, the electromagnetic field 206 enables an uplink connection between the user equipment 110, 120, 130 and a base transceiver station 108, 118, 250. The antenna element 202 may be a patch antenna or a dipole, for example. The invention is not restricted to certain frequencies but may be applied to any radio frequency utilised in a wireless telecommunication system.

In transmission, a digital transmit signal 212 is inputted into the transceiver 208A, 208B. The digital transmit signal 212 is converted into a radio frequency transmit signal 204 by the transceiver 208.

In reception, the transceiver 208 converts the receive radio frequency receive signal 204 into a low-frequency digital output signal 212, and outputs the low-frequency digital output signal 212.

In an embodiment, the low-frequency digital signal 212 represents a signal similar to a base band signal used in base band parts in a base transceiver station. The format of the low-frequency digital signal 212 may, however, differ from that used in conventional base band parts.

In this embodiment, the antenna arrangement comprises an antenna adapter 214 connected to the at least one active antenna 200 for providing a digital link 22 for the at least one active antenna 200.

In reception, the antenna adapter 214 receives the low-frequency digital output signal 212 from the active antenna 200 and converts the low-frequency digital output signal 212 into a digital signal for transmission over the optical digital link 22.

In transmission, the antenna adapter 214 receives optical radiation carrying the digital signal over link 22, detects the optical radiation with a light detector, and converts the optical radiation into an electric form. The signal will be further processed to generate the radio signal for transmission.

In reception, the antenna adapter 214 may modulate the optical radiation such that the information content of the low-frequency digital output signal 212 is transferred into the digital signal. The optical radiation may be produced by using known techniques, such as light emitting semiconductors.

The digital signal may be transported/distributed by using optical channels based on optical properties, such as polarisation or an optical wavelength, of the optical radiation used in implementing the digital signal. The optical components and methods used in the implementation of the optical channels are known to a person skilled in the art.

The optical form of the digital signal, for example, enables high information transfer capacity over the link 22.

The RRU includes an interface signal processing unit (ISPU) 222 connected to at least one active antenna 200A, 200B and the antenna adapter 214 for processing signals 212A, 212B, 210A, 210B transmitted between the active antenna 200A, 200B and the antenna adapter 214. The interface signal processing unit 222 may separate different frames in the digital signal and possibly code the frames into suitable format for the transceiver 208A, 208B. The separation includes, for example, separating payload data and control data from the bit stream, and routing the different types of data into suitable connectors of the transceiver 208A, 208B. Furthermore, the interface signal processing unit 222 may combine data of different optical channels and/or direct the data to different optical channels. The combining includes forming the bit stream from the digital receive signal 212, and possibly from control signals such that the digital signal to be transmitted from the antenna adapter 214 has a predetermined frame structure. The RRU also contains a control unit 242 for performing various control functions. In particular, the control unit 242 sets electrical parameters of the remote radio unit. In the system described above, all RRUs receive during operation the same control message. However, it would be possible to send dedicated control messages for individual basic settings during the installation/initialisation phase of the base station. In that case, the control unit 242 could configure the RRU accordingly.

The above described embodiments of the present invention apply to any code division multiple access (CDMA) air interface standard, such as wideband CDMA, CDMA 2000 or time division (TD)-SCDMA. RAKE receivers at the base band modules are able to separate the signals of individual terminals due to the channelisation and scrambling codes which have been used.

The advantage of using the digital radio head combiner is that fewer signals need to be routed within the distributed base station system. In particular this provides cost reduction on the interface between the local units and the base band modules or, alternatively, enables very large distributed base station configurations.

While in the described embodiment optical fibre links are utilised, it will be appreciated that other forms of digital links can be used, such as radio links, coax cable or free space optics.

One possible drawback of the above-mentioned system is the performance penalty in uplink reception, since the summing of the individual signals may result in a lower signal to noise ratio. Therefore, the invention is particularly useful in a situation where multiple radio units/antennas are needed to achieve sufficient radio coverage. When walls or floors prohibit coverage from wide area base station, reduced sensitivity of the local area radio might even improve the overall network performance. Further, limiting the number of signals which are added together can control the loss of the performance according to the particular requirements of each installation.

1. A wireless communications system comprising:
a plurality of radio units each comprising at least one antenna for receiving a radio frequency signal over a wireless interface, a converter for converting the radio frequency signal to a digital signal and a digital link for conveying the digital signal;
a digital combiner for receiving digital signals from the plurality of radio units and combining the digital signals in a digital domain to generate a resultant digital signal and having a digital link for conveying the resultant digital signal; and
a processing unit arranged to receive and process the resultant digital signal.

2. The wireless communications system according to claim 1, wherein the digital signal from each radio unit has a predetermined data rate and the digital combiner is operable to decimate the data rate of each of the received digital signal.

3. The wireless communications system according to claim 2, wherein the data rate is decimated so that the resultant digital signal has the data rate corresponding to one of said digital signals.

4. A wireless communications system according to claim 1, wherein the processing unit comprises a digital distributor arranged to receive a combined digital signal and to generate therefrom a plurality of individual digital signals and to convey said individual digital signals over respective digital links associated with each of the plurality of radio units.

5. The wireless communications system according to claim 4, wherein the distributor is arranged to encode each of said individual digital signals with a common spreading code.

6. The wireless communications system according to claim 4, wherein the distributor is arranged to encode each of said individual digital signals with a different spreading code.

7. The wireless communications system according to claim 1, wherein the processing unit comprises a digital distributor arranged to receive a combined digital signal and to generate therefrom a single digital signal, said single digital signal being transmitted over respective digital links associated with each of a plurality of radio units.

8. The wireless communications system according to claim 1, wherein each digital signal has a defined structure and includes digital samples representing the radio frequency signal.

9. The wireless communications system according to claim 2, wherein each digital signal has a defined structure and includes digital samples representing the radio frequency signal and wherein the digital combiner is operable to sum the digital samples of respective digital signals to generate the resultant digital signal.

10. The wireless communications system according to claim 8, wherein the defined structure comprises packets, each packet comprising a header and a payload, wherein the payload includes said digital samples.

11. The wireless communications system according to claim 10, wherein the digital combiner is operable to sum the digital samples of the payloads of packets of respective digital signals to generate the resultant digital signal.

12. A wireless communications system according to claim 11, wherein the resultant digital signal is in the form of a sequence of packets, each packet including a payload portion generated by summed samples of the payload portions of packets of the digital signals, and a header portion generated from the headers of packets of the digital signals.

13. The wireless communications system according to claim 9, wherein the defined structure takes the form of frames.

14. The wireless communications system according to claim 1, wherein the digital link of each radio unit is selected from an optical fibre link, a radio link and free space optics.

15. The wireless communications system according to claim 1, wherein the processing unit includes a RAKE receiver.

16. The wireless communications system according to claim 15, wherein said plurality of radio units are located in a common location for receiving a single radio frequency signal over a plurality of differing paths, and wherein the RAKE receiver is operable to process the resultant digital signal.

17. The wireless communications system according to claim 16, wherein the radio frequency signal is encoded using a spreading code.

18. The wireless communications system according to claim 16, wherein the plurality of radio units are located to receive separate radio frequency signals encoded with differing spreading codes, and to transmit said signals to the digital combiner wherein the RAKE receiver is operable to process the resultant digital signal.

19. The wireless communications system according to claim 1, wherein the processing unit comprises a transmitter arranged to receive a combined digital signal and to generate therefrom a plurality of individual digital signals, said digital signals being conveyed over respective digital links associated with each of the plurality of radio units and said digital signals conveying dedicated control information.

20. The wireless communications system according to claim 2, wherein the data rate is decimated so that the resultant digital signal has a data rate which has a bit overhead per radio unit.

21. A digital combiner for use in a mobile communications system having a plurality of radio units each being capable of generating a digital signal representative of a radio frequency signal received over a wireless interface, the digital combiner being operable to:
receive digital signals from the plurality of radio units; and
combine the digital signals in a digital domain to generate a resultant digital signal,
wherein the digital combiner further comprises a digital link for conveying the resultant digital signal.

22. The digital combiner according to claim 21, wherein each digital signal has a predetermined data rate.

23. The digital combiner according to claim 22, wherein the digital combiner is operable to decimate the data rate of each of the received digital signals so that the resultant digital signal has a data rate corresponding to one of said digital signals.

24. The digital combiner according to claim 21, wherein each digital signal has a defined structure including digital samples representing the radio frequency signal, wherein the digital combiner is operable to sum the digital samples of the respective digital signal to generate the resultant digital signal.

25. The digital combiner according to claim 21, wherein the digital link comprises a Lu interface.

26. A digital distributor for use in a mobile communications system, having a plurality of radio units, each being capable of receiving a digital signal and converting it to a radio frequency signal for transmission over a wireless interface, the digital distributor being operable to:
receive a combined digital signal;
generate therefrom a plurality of individual digital signals; and
convey said digital signals over respective digital links associated with each of a plurality of radio units.

27. The digital distributor according to claim 26, wherein the digital distributor is arranged to encode each of said digital signals with a common spreading code.

28. The digital distributor according to claim 26, wherein the digital distributor is arranged to encode each of said digital signals with a different spreading code.

29. A digital radio head combiner for use in a mobile communications system having a plurality of radio units, each capable of receiving a digital signal and converting it to a radio frequency signal for transmission over a wireless interface, the digital distributor, comprising:
a digital combiner configured to receive digital signals from the plurality of radio units, and combine the digital signals in the digital domain to generate a resultant digital signal, wherein the digital combiner further comprises a digital link for conveying the resultant digital signal; and
a digital distributor configured to receive a combined digital signal, generate therefrom a plurality of individual digital signals, and convey said digital signals over respective digital links associated with each of a plurality of radio units.
